(19) United States
(12) Patent Application Publication
(10) Pub. No.: US 2008/0101880 A1
(43) Pub. Date: May 1, 2008

(54) Method of and Apparatus for Milling Workpieces Such as Camshafts

(76) Inventor: Bramwell W. Bone, Osprey, FL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/939,230

(22) Filed: Nov. 13, 2007

Related U.S. Application Data
(63) Continuation of application No. PCT/US06/18036, filed on May 10, 2006.
(60) Provisional application No. 60/680,934, filed on May 13, 2005.

(51) Int. Cl. B23C 3/08; B23P 15/00; B24B 19/12

(52) U.S. Cl. 409/131; 29/888.1; 409/197; 409/200

(57) ABSTRACT

A milling apparatus and method are provided for generating eccentric camshaft lobes with a peripheral surface that is parallel to the horizontal axis of the camshaft for preferably the entire 360° peripheral surface of the lobe. In one form, the cutter is shifted during milling so that the cutting insert is cutting the peripheral surface on the lobe that is always parallel to the camshaft axis. The cutter head can be tilted to keep the cutting edge straight and parallel to the camshaft axis and, as the cutting head pivots the cutting edge, it also moves sideways with the width of the cutter covering the width of the lobe's peripheral surface. If an eccentric lobe is of a drastic shape where the cutting edge does not cover the entire width of the lobe, a fourth axis may be used in an interpolative manner to keep the cutting edge always bridging the lobe surface.

### RELATED APPLICATIONS

This application is a continuation of PCT application No. PCT/US2006/018036, filed May 10, 2006, which claims priority to U.S. Provisional Application No. 60/680,934, filed May 13, 2005, the contents of which are hereby incorporated by reference herein in their entirety.

### FIELD OF THE INVENTION

This invention relates to a method of and an apparatus for milling workpieces such as camshafts to provide cam profiles thereon.

### BACKGROUND OF THE INVENTION

The present invention is directed to an improved method and apparatus for milling camshafts with milling machines such as those disclosed in U.S. Pat. Nos. 4,551,048 and 4,624,610. The milling machine disclosed in these patents comprise the interpolation of a rotating workpiece rotating about a horizontal axis through the camshaft and of the infeed of the tool generating the lobe on the camshaft while varying the speed of rotation of the crankshaft and infeed travel of the cutting tool. The lobe is machined by a milling head having a plurality of cutting inserts in a circular arrangement on a conical face portion of the milling head. The cutting edges move in a path that is defined by a frustum of a cone concentric with the axis of the milling head and the cutting edges lie in a plane which forms an acute angle with the longitudinal axis of the camshaft. The cutting edge takes a progressive cut beginning on one side of the cam with a substantial force vector components being directed axially of the camshaft.

A problem with this milling machine is that it does not produce a flat or parallel lobe surface due to the conical shape of the cutter and because the cutter moves only on an infeed axis toward or away from the camshaft axis, and because the cutter is held in a fixed angular position during the milling process. During the milling of the camshaft lobe, a tangent point of the cutting edge against the workpiece changes as the past rotates. This change in the tangent results in milling a flat surface on the cam only when the tangent point is in line with the center axis of the camshaft. Anything milled off of this center line will finish up with the resultant angle of insert at its tangent/cutting point on the lobe producing what could be called a rounded or egg-shaped outer peripheral surface on the cam lobe.

As a result of this failure to produce a flat or parallel peripheral surface on the cam lobe, a considerable amount of metal must be removed such as by a grinding process to provide the desired flat, peripheral lobe surface when using the prior art milling machines to do the milling operation. After milling and grinding, the peripheral cam surface is polished and it would be desirable to produce a flat, parallel surface that eliminates the need for a subsequent grinding of the cam lobe peripheral surface.

### SUMMARY OF THE INVENTION

In accordance with the illustrated embodiments, an improved milling apparatus and method, as contrasted to the prior art, is disclosed that produces eccentric camshaft lobes with a peripheral surface, which surface is parallel to the horizontal axis of the camshaft about the entire 360° peripheral surface of the lobe. This is achieved by shifting the cutter during the milling process so that the cutting insert is cutting a peripheral surface on the lobe which surface is always parallel to the camshaft axis. In one embodiment, the cutter head is tilted to keep the cutting edge straight and parallel to the camshaft axis, as the cutting head pivots the cutting edge, it also moves sideways which is not a problem so long as the width of the cutter covers the width of the lobe's peripheral surface. If, however, an eccentric lobe is of drastic shape where the cutting edge does not cover the total width of the lobe, a fourth axis may be used in an interpolative manner to keep the cutting edge always bridging the lobe surface.

In accordance with another embodiment, rather than tilting or pivoting the head about a pivot axis, the cutter is moved laterally along another axis, herein called a “Z” axis, so that the tangent point of the cutter is always in line with the tangent point on the lobe by following the lobe with the cutting head moving as the cam rotates in order to maintain a flat and parallel, peripheral surface on the camshaft lobe.

In accordance with another aspect of the invention, the milling method and apparatus may be positioned to cut two different camshaft profiles on the same lobe using a cutter having cutting elements mounted in a circular arrangement on a conical face portion of the cutter. This is achieved in the illustrated embodiment by positioning the outer head to rotate about a first axis when milling the first cam shaft profile and indexing the cutter to rotate about a second axis for milling the second cam profile with each of the cam profiles having peripheral, milled surfaces flat and parallel to the camshaft axis.

In accordance with the preferred embodiment, the milling cutter is mounted on a vertically extending cutter table or slide to move the cutter vertically toward or away from the camshaft in accordance with the particular cam profile desired to be cut using conventional controls such as a computer and apposition sensor.

In accordance with an embodiment of the invention, the eccentric cams are machined with such flat, parallel surfaces that the surfaces may be polished without an intervening grinding of the peripheral lobe surfaces.

In accordance with another aspect of the invention, the milling heads may be positioned to be vertical to position the cutters for removal in a wine rack or the like and to move over and pick up two new cutters and come back to position without having to shut down the machine to change tools.

In accordance with a further aspect of the invention, two cam shafts may be milled simultaneously with two spindle heads coming in from the top rather than using a pivoting fixture for a single crankshaft. That is, two camshafts will be lowered into position between their respective head centers and tailstock centers. Moreover, with the spindles and milling heads above the camshaft, the chips are free to fall by gravity without dropping on the spindles and it may be clear beneath the camshafts for chip removal.

### BRIEF DESCRIPTION OF THE DRAWINGS

FIG. 1 is a front elevational view of a milling apparatus constructed in accordance with an embodiment and embodying the invention;

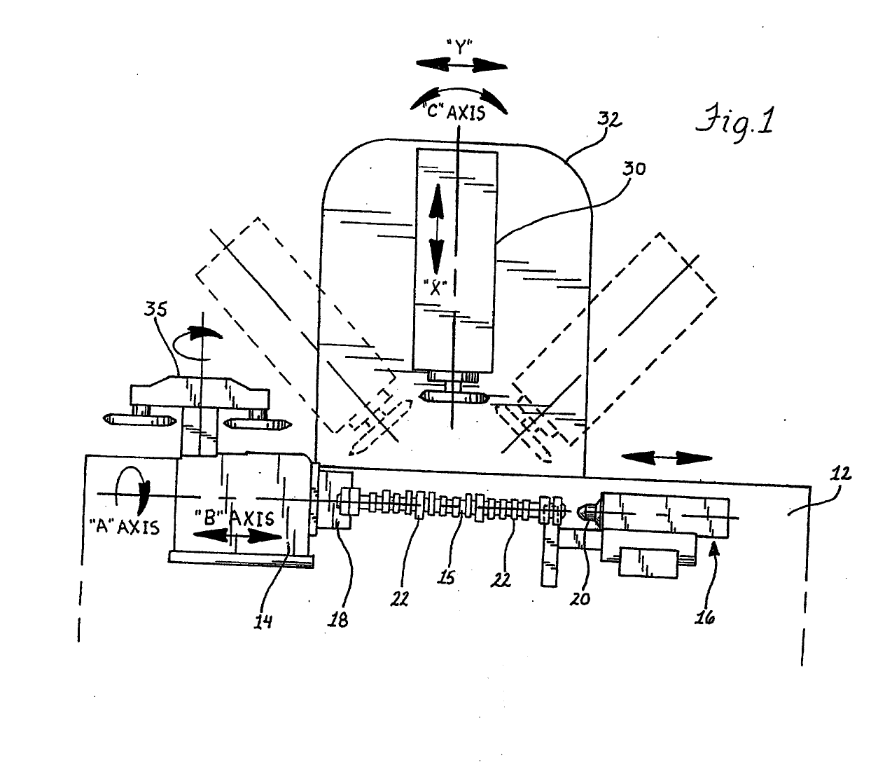

FIG. 2 is a diagrammatic illustration of the changing of the tangent points of the cutter during an infeed of the cutter along an X-axis when using the prior art machines;

FIG. 3 is a diagrammatic view showing the tangent line and tangent points away from the center axis;

FIG. 4 is a diagrammatic illustration of an embodiment of the invention where the cutter head pivots or tilts about a C-axis to keep the cutting edge always parallel to the camshaft axis as the milling head infeeds to cut a cam profile;

FIG. 5 is a diagrammatic illustration of another embodiment in which the cutting head shifts along a Z-axis during infeed of the milling head so that the tangent point of the cutting edge is always in line with the tangent point on the lobe being cut to provide the flat parallel surface on the cam lobe;

FIG. 6 is a diagrammatic illustration of a milling cutter being repositioned to rotate about axis 1 and axis 2 to cut two different camshaft profiles on the same cam lobe;

FIG. 7 is a side-elevational view of the apparatus shown in FIG. 1; and

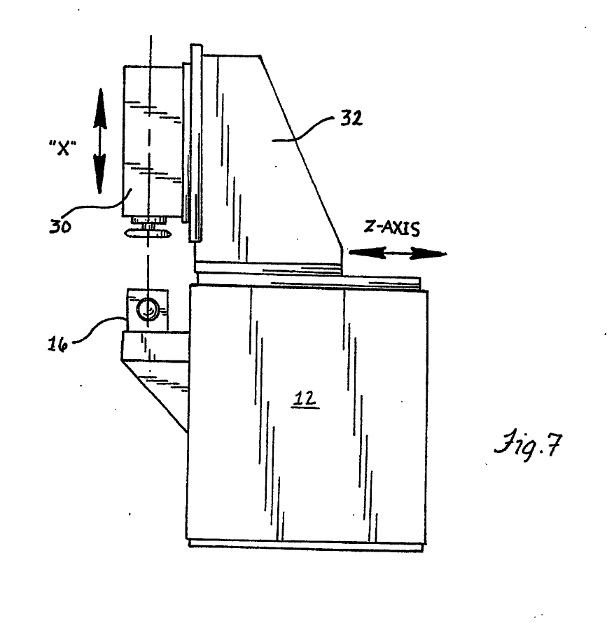

FIG. 8 is a view of a cutting head with cutting inserts with a diameter small enough to allow a reentry curve to be machined onto the cam lobe.

### DETAILED DESCRIPTION OF THE PREFERRED EMBODIMENTS

Referring now to the drawings, there is disclosed an apparatus 10 having a frame or base 12 which supports a headstock 14 and a tailstock 16 between which is disposed for rotation a rotatable cam shaft 15. The headstock is moveable along a slidable axis B relative to the base 14 and comprises a centering chuck and spindle 18 with a workpiece locating and clamping means for rotating the camshaft in a conventional manner by a servo motor on the headstock which rotates the camshaft about an axis “A.” The axis “A” is the longitudinal axis of the camshaft. The tailstock 16 has a camshaft work supporting center 20 for engaging in this instance the right hand end of the camshaft 15. The aligned work supporting centers 18 and 20 on the headstock and the tailstock are spaced from each other and are aligned and support the elongated workpiece 15 as the head center 18 is driven by a variable speed motor to rotate the cam shaft which has the numerous projecting eccentric lobes 22 projecting radially from the axis of the cam shaft. The radial projections or lobes 22 may be initially circular or they may be already generally eccentric but they are to be milled to non-circular configurations to have a desired cam profile by a milling cutter 30 which is mounted on a table and in this instance is preferably disposed for vertical movement along an X-axis for the reasons to be described hereinafter. The milling cutter is mounted on a frame 32 that is affixed at its lower end to the base 12 and projects vertically upward and supports a typical compound slide that may have a Z-axis table and a Y-axis table with a servo feed along a C-axis for pivoting the cutter spindle to any acute angle to the camshaft axis “A” required to perform the milling operation. The cutter spindle and milling cutter are preferably shifted to a vertical position for a tool change by a tool changer 35. Illustrated tool changer 35 is preferably a pivoting wine rack tool changer that provides automatic tool change in a conventional manner with a vertical dropping and lifting of milling tools.

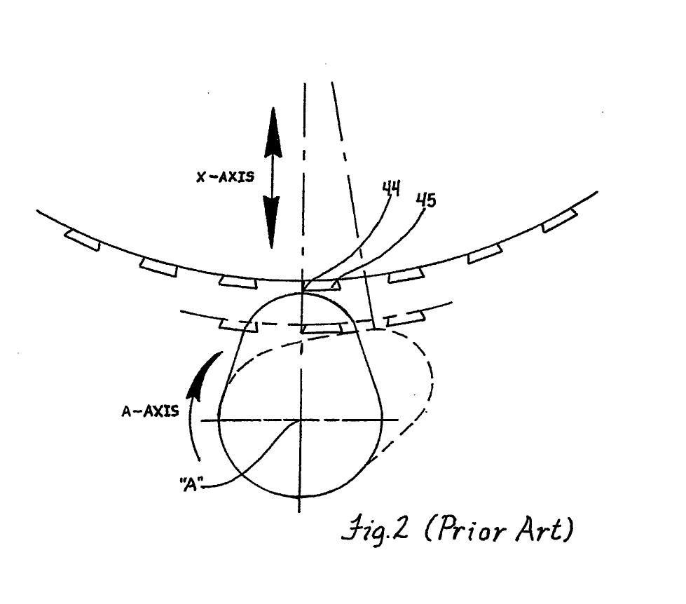

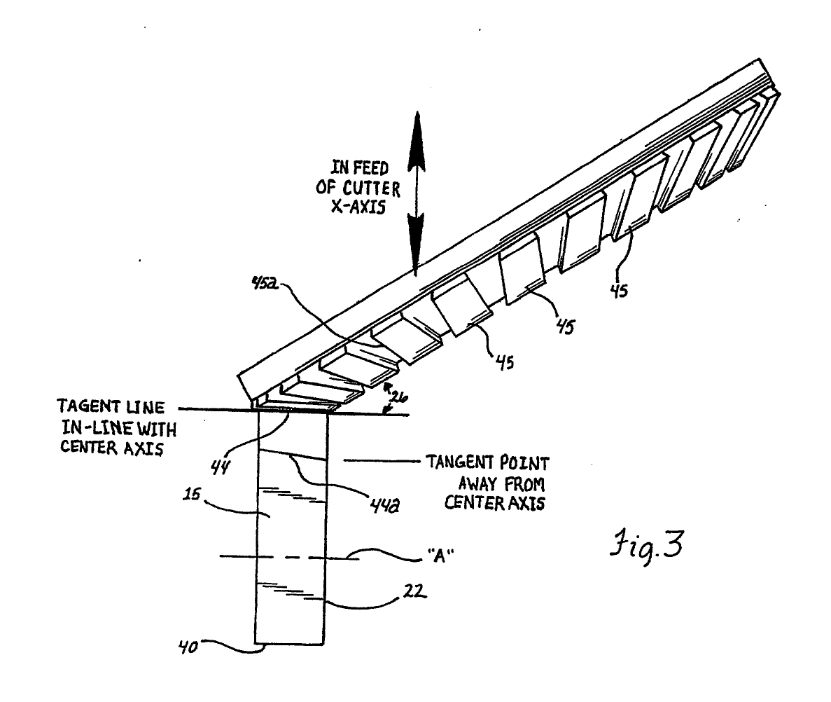

FIG. 2 illustrates the prior art machining that was done using the apparatus and methods disclosed in U.S. Pat. Nos. 4,551,048 and 4,624,610 in which the cutter only moves on an infeed axis-X towards and away from the camshaft axis-A as shown in the solid line position. In these prior art milling machines, the cutter is held in a fixed angular position 26 (FIG. 2) which is at an acute angle, e.g., 20° with the camshaft axis “A” during the milling process. This can be seen in FIG. 2. During the milling of the camshaft lobe, the tangent point 44 of the cutter insert 45 against the workpiece lobe changes as the lobe and camshaft rotates to turn different areas on the lobe into engagement with a cutting insert. Because the cutting tool is conical in shape, the insert's cutting edge mills only a flat surface on the cam shaft lobe when the tangent point 44 is aligned with the center axis of the cam shaft. However, anything milled off the center line as when center line 44a will finish up with the resultant angle of the insert at its tangent cutting point on the lobe which is a non-flat surface, as shown by the inclined tangent line 44a in FIG. 3. That is, a non-flat tangent line surface is shown at the point 44a in FIG. 3. More specifically, the cutter is only a tangent line shown in solid lines at 44 in FIG. 3 to provide the flat planar surface that is desired all around the peripheral surface 46 of the cam lobe. One result of the failure to provide a flat parallel, peripheral lobe surface 40 all around the periphery of the cam lobe is that the inclined material must be taken away to provide the desired surface usually by an extensive grinding operation.

The present invention is directed to eliminating grinding that is needed following the milling operation of the cam lobes when using the above-described prior art machines.

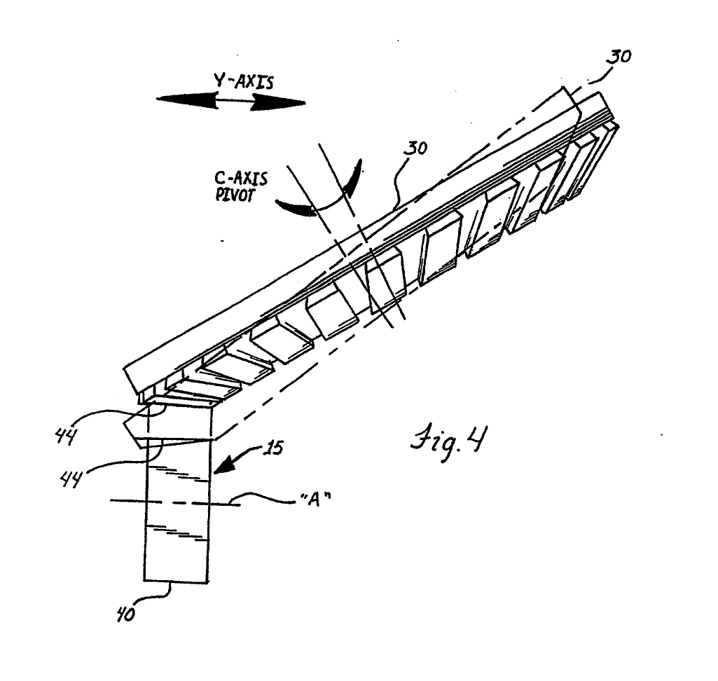

In accordance with the present embodiment and as will be described in connection with FIG. 4, there is provided a third C-axis for the milling head which allows the cutting head is shifted relative to the camshaft axis during the milling of the camshaft lobe so that the milling head 30 which allows the cutting head 32 to be shifted so that the cutting edge 45a of the insert 45 that is cutting the camshaft lobe is always parallel to the camshaft axis A at the time of cutting. More specifically, the solid-line position in FIG. 4 shows the milling head 35 in a first position and at a first angle with respect to the cam lobe 22 on the cam shaft 15 and then the dotted line position shown in FIG. 4 shows a pivoting of the milling head 35 to a second position where the milling cutting edges 45a are still parallel to the cam shaft axis A′. As the cutting head 35 pivots or tilts, it will move sideways as can be seen in FIG. 4 which, so long as the width of the cutter covers the width of the cam lobe, is not a problem. However, on eccentric lobes 22 of rather drastic shape, the cutting edge 45a may not cover the total width across the lobe a fourth axis Y could be used in interpolation to keep the cutter always bridging the lobe surface. In the embodiment of FIG. 4, there is a pivoting of the cutter head about the C-axis during the infeed so that the milled peripheral surface on the cam shaft lobe is parallel to the camshaft axis rather than being egg-shaped as in the prior art milling.

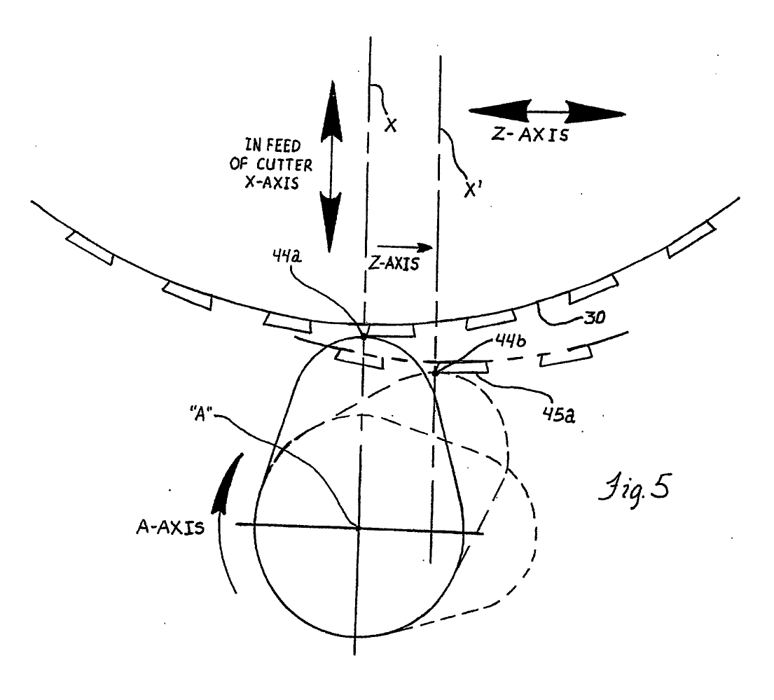

Another embodiment of the invention is illustrated in FIG. 5 wherein during the infeed of the milling head 35 and the cutting inserts 45 while milling the peripheral lobe surface, the milling head 35 is shifted in a direction along a third axis “Z,” as illustrated in FIG. 5. This shifting along the Z-axis allows the cutter to move laterally along generally parallel paths X and X′ in FIG. 5, so that the cutter and the tangent point 44a or 44b of the insert cutting edge 45a is always in line with the tangent point on the lobe being cut in order to maintain a flat parallel surface on the peripheral surface of the cam lobe. In the embodiment of FIG. 5, when the cam lobe's highest point is uppermost, as shown in solid lines in FIG. 5, the tangent line is in alignment with a vertical axis “X” for the milling cutter which is in line with the cam axis “A.” To mill a trailing portion of the lobe's highest point, the milling head is shifted laterally to an X′ axis position, i.e., laterally as shown in FIG. 5 along the Z-axis and the cutter head has been infed downwardly to cut along a tangent line 44b to provide a milled surface that is parallel to the camshaft axis “A.”

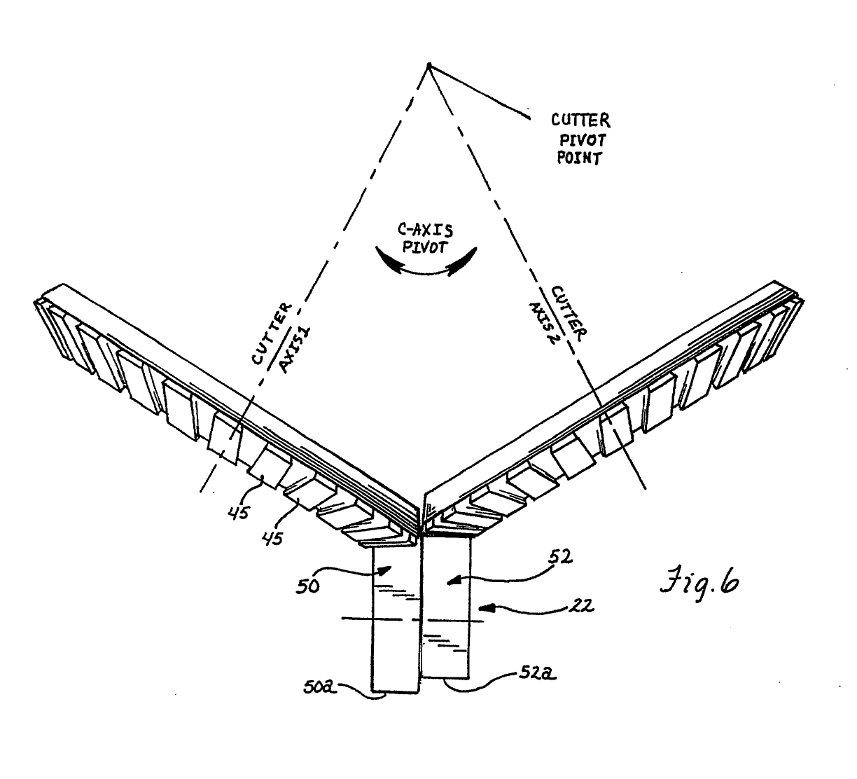

In accordance with another aspect of a further embodiment, there is the ability using the vertically disposed cutter particularly to allow the cutter to be moved to cut either a first cam profile 50 or a cam lobe and a second cam profile 52 or cam lobe, as will be explained in connection with FIG. 6. It is desired to have a flat peripheral surface 50a and 52a on the respective cam profiles. Herein, the milling cutter head 35 may cut the first cam profile 50 with the inserts 45 being arranged to rotate around a first cutter axis 1 for milling the first cam profile. In a second operation, the milling cutter head 35 is repositioned for rotation around a cutter axis 2 for cutting the peripheral surface 52a for the second cam profile. In the usual operation where there are two cam profiles to be made on a single lobe 22, the cam profiles 1 would be cut successively one after another along the length of the camshaft before the cutter would be repositioned for cutting those cam lobes having a second cam profile. After this, the cutter was indexed about its pivot point on the frame to rotate about the cutter axis 2; and then it successively cut the cam profiles 2 with the cutter shown in the second or right hand position on the respective lobes 22 of the camshaft. The machine forming the dual camshaft profiles on the same lobe may consist either of a single or multiple spindle cutter design so that one or more cam shafts may be milled simultaneously.

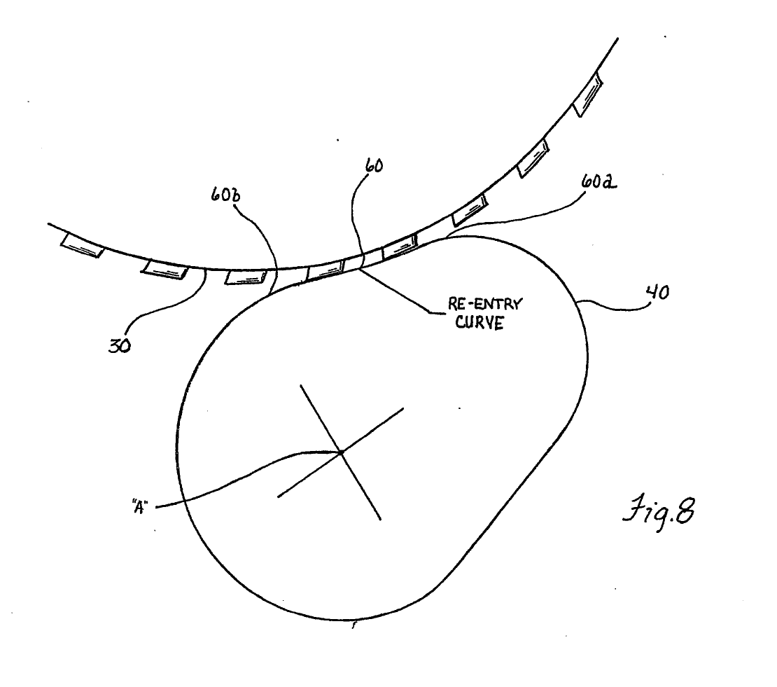

In the embodiment shown in FIG. 8, the cutter head 35 is provided with angular inserts around the periphery and the inserts and the cutter head have such a small diameter that a reentry curve 60 may be machined on the peripheral surface of the cam lobe. In the embodiment of FIG. 8, the cutting inserts may be positioned so that the tangent point of the cutter against the workpiece changes as the cam lobe rotates so that the peripheral surfaces are parallel to the horizontal axis “A” of the camshaft 360° about the lobe illustrated in FIG. 8. That is, the cutting head and inserts cannot have a larger radius than that of the radius of the reentry curve because the inserts 45 must be able to go into the reentry curve area without hitting adjacent points where the concave reentry surface 60 rejoins the convexly curved surfaces on the remainder of the cam profile.

In accordance with the preferred method, the camshaft 15 is supported for rotation between the headstock and the tailstock turning centers 18, 20 and the camshaft is turned preferably at a speed that is varied under computer control. The angular position of the cam shaft is sensed and detected and fed as an input to the computer which calculates the cam radius at that particular position and the speed of rotation of the cam shaft. The milling cutter 30 having the rotating milling head 35 with the rotating inserts 45 rotates with the cutting edges 45a being in a circular array around the axis of rotation of the milling head and with the cutting edges in a plane the path of which forms an angle of less than 90° with a camshaft axis. A typical angle may be around 20°. This is the angle that the conical surface of the milling head makes with a plane perpendicular to the axis of the rotation of the milling head. A motor (not shown) turns the milling head to provide the desired cutting speed for the insert; and as the camshaft rotates, the milling head inserts are brought into operative relation with the periphery of the lobes which are to be milled into eccentric cam lobes. As the milling head rotates, the cutting inserts move rapidly through the circular path, each taking a chip from the periphery of the lobe but in this instance, the cutting edges are being repositioned relative to the camshaft so they cut the camshaft lobes peripheral surface at tangent lines parallel to the camshaft axis “A” which minimizes or reduces the need for the expensive and time consuming grinding operation that is typically used heretofore when using machines of the type disclosed in these prior art patents described above. In the embodiment of FIG. 4, the milling head is pivoted about an axis “C” to keep the tangent line 44 parallel to the camshaft axis “A.” The milling head pivots between the positions as shown in solid and dotted lines in FIG. 4. As an alternative to the pivoting action shown in FIG. 4 and described in connection therewith, while the interpolation is taking place, the cutting head could be moved along a third Z-axis as shown in FIG. 5 between X and X′ positions so that the tangent point of the cutter insert cutting edge is in line with the tangent point 44a or 44b on the lobe as shown in the solid line figure as well as in the dotted line FIG. 5 to maintain a flat and parallel surface on the camshaft lobe.

In accordance with a further aspect of this method of the preferred invention, the cutter axis may be shifted as shown in FIG. 6 so that it is able to cut two different cam shaft profiles 50 and 52 on the same lobe 22. Preferably all of the profiles that would be cut with the cutter axis in the general position of FIG. 6 along the cutter axis 1 would be machined and then the milling head would be repositioned about the C-axis pivot point to have the head rotate about the cutter axis 2 and then all of the cam profiles 2 would be cut with the cutter in the position shown in FIG. 6.

In the method of the present invention, it is also desirable to be able to cut reentry curves and this is provided by using a sufficiently small diameter cutting head and inserts to cut the concave reentry curve between the convex curves on the lobe, as shown for the camshaft lobe in FIG. 8. The camshaft lobe will have a peripheral surface over the reentry curved portion which is parallel to the camshaft axis “A.”

What is claimed is:

1. A method of making an eccentric cam on a camshaft comprising:
supporting and rotating a camshaft about its longitudinal axis;
providing a milling cutter having a rotating milling head rotatable about an axis with cutting edges in a circular array about the axis of rotation of the milling head;
positioning the cutting edges to move in a path, the plane of which forms an angle of less than 90° with the camshaft axis;
rotating the milling head and feeding the milling head toward and from the axis of the camshaft to a peripheral surface on an eccentric cam lobe; and
shifting the cutting edges relative to the camshaft lobe while milling the lobe's peripheral surface so that the cutting edges cut the camshaft lobe's peripheral surface to be parallel to the cam shaft axis.

2. A method in accordance with claim 1 wherein the shifting of the cutting edges comprises:
pivoting the milling head about another axis so that as the milling head moves toward or from the cam lobe, the tangent points of the cutting edges being always in line with the center axis of the camshaft.

3. A method in accordance with claim 1 wherein the shifting of the cutting edges comprise:
moving the cutting head along a Z-axis.

4. A method of making two cam profiles on a camshaft lobe comprising:
supporting and rotating a camshaft about its longitudinal axis;
providing a milling cutter having a rotating milling head rotatable about a first axis with cutting edges in a circular array about the axis of rotation of the milling head;
positioning the cutting edges to move in a path, the plane of which forms an angle of less than 90° with the camshaft axis;
rotating the milling head and feeding the milling head toward and from the axis of the camshaft and cutting a peripheral surface on the cam lobe to form a first cam profile;
repositioning the milling cutter to rotate about a second axis and feeding the milling head toward the camshaft lobe and cutting the peripheral surface of the cam lobe to form a second cam profile adjacent the first cam profile; and
shifting the cutting edges so that they cut the camshaft lobe's peripheral surface to be parallel to the cam shaft axis.

5. An apparatus for making an eccentric cam on a camshaft comprising:
supports for supporting and rotating a camshaft about its longitudinal axis;
a milling cutter having a rotating milling head rotatable about an axis;
cutting edges in a circular array about the axis of rotation of the milling head;
the milling cutter positioning the cutting edges to move in a path, the plane of which forms an angle of less than 90° with the camshaft axis;
a drive for rotating the milling head and for feeding the milling head toward and from the axis of the camshaft to a peripheral surface on an eccentric cam lobe; and
a shifter for shifting the cutting edges so that they cut the camshaft lobe's peripheral surface to be parallel to the cam shaft axis.

6. A milling machine for milling eccentric lobes on a camshaft;
a base;
a headstock on a sliding axis “B” having a spindle, workpiece locating clamping and rotating means by a servo motor axis “A;”
a tailstock with a quill and center that is adjustable for different lengths of camshafts;
a cutter spindle mounted to a compound slide with Y and Z-axis servo feed along with a “C” axis for pivoting the cutter spindle to an angle to cut an eccentric cam lobe with the peripheral surface of the lobe being parallel to a rotating axis for the camshaft about 360° of the eccentric lobe.

7. A method of making an eccentric cam on a camshaft comprising:
supporting and rotating a camshaft about its longitudinal axis;
providing a milling cutter having a rotating milling head rotatable about an axis with cutting tools having cutting edges in a circular array about the axis of rotation of the milling head;
positioning the cutting edges to move in a path, the plane of which forms an angle of less than 90° with the camshaft axis;
rotating the milling head and feeding the milling head toward and from the axis of the camshaft to a peripheral surface on an eccentric cam lobe; shifting the cutting edges so that they cut the camshaft lobe's peripheral surface to be parallel to the cam shaft axis; and
positioning the milling head substantially vertically and allowing two crank shafts to be machined simultaneously and facilitating an automatic changing of the cutting tools.
